(19) United States
(12) Patent Application Publication
(10) Pub. No.: US 2002/0064173 A1
(43) Pub. Date: May 30, 2002

(54) Broadcasting apparatus using OFDM modulation method

(75) Inventor: Shinji Watanabe, Tokyo (JP)

Correspondence Address: STEVEN I. WEISBURD, ESQ., DICKSTEIN SHAPIRO MORIN & Oshinsky LLP, 1177 AVENUE OF THEAMERICAS- 41stFLOOR, NEW YORK, NY, 10036-2714, US

(73) Assignee: NEC Corporation

(21) Appl. No.: 09/998,445

(22) Filed: Nov. 30, 2001

(30) Foreign Application Priority Data
Nov. 29, 2000 (JP) 2000-362049

(51) Int. Cl. H04Q 11/02

(52) U.S. Cl. 370/430; 370/206

(57) ABSTRACT

A modulation level of a carrier for video and a modulation level of a carrier for voice are adjusted in a modulation level setting circuit 5 and a modulation level setting circuit 10, respectively, so that receivable ranges of a video signal and a voice signal become the same range. Next, both of video and voice modulation signals are amplified in a transmission device 23, and are transmitted.

### BACKGROUND OF THE INVENTION

The present invention relates to a broadcasting apparatus using an OFDM (Orthogonal Frequency Division Multiplexing) modulation method, and especially, to a broadcasting apparatus using an OFDM modulation method, which is used for a ground digital broadcasting system.

FIG. 7 is a view showing one example of frequency allocation of television broadcasting. As shown in the FIG. (A), in the current analog television broadcasting, for example, a band of 6 MHz, which is a predetermined frequency, is allocated to a first channel, and a band of 6 MHz, a frequency of which is higher than the first channel, is allocated to a second channel, and a band of 6 MHz, a frequency of which is higher than the second channel, is allocated to a third channel, so that different bands of 6 MHz are allocated to each channel.

On the other hand, as shown in the FIG. (B), showing a case of an apparatus (referred to as an ISDB-T apparatus, hereinafter) of the ground digital broadcasting system in Japan as one example, in the frequency allocation of the ground digital broadcasting system, a band for one channel is 6 MHz similar to the conventional one, and however, the band is divided into 13 segments, and a modulation method and a coding rate or the like are set for each segment.

Next, this segment will be explained. First, a video signal and a voice signal of a broadcasting object are converted into a digital signal in a studio device mentioned later, and thereafter, signal compression is applied thereto. The digital signal to which the signal compression has been applied is first divided into a plurality of layers. The ISDB-T apparatus is constructed so that one channel is divided into at most 4 layers. For example, as shown in the FIG. (B), in each channel (the second channel in an example of the figure), a seventh segment S7 is allocated to a layer 1, and twelve segments of a first segment S1—a sixth segment S6 and an eighth segment S8—a thirteenth segment S13 are allocated to a layer 2.

In this example, the seventh segment S7 is used for voice signal transmission of a QPSK (Quadrature Phase Shift Keing) method, and the first segment S1—the sixth segment S6 and the eighth segment S8—the thirteenth segment S13 are used for video signal transmission of a 64QAM (64-positions Quadrature Amplitude Modulation) method. In this example, although the intermediate seventh segment S7 is allocated to a voice signal, in this, a case for example where it is received by a reception device for only a voice signal is supposed.

Also, a plurality of carrier waves, for example 108 carrier waves (referred to as carriers, hereinafter) exist for each segment. In addition, in this example, layers 3 and 4 are not used.

FIG. 8 is a circuit arrangement view of one example of a conventional broadcasting apparatus. The figure shows one example of a modulation device out of the broadcasting apparatus. Here, bit data D1 and D2 indicate digital data for every layer, which are sent from a studio device, and a control data (referred to as a CONT data, hereinafter) C1 includes a modulation method, an error correction coding rate and other layer arrangement information for every segment of each layer. Referring to the figure, the conventional modulation apparatus is constructed of S/P conversion circuits 1 and 6 for converting a serial data into a parallel data in accordance with a modulation method, interleave circuits (interleavers) 2 and 7 for delaying and interleaving a data for every bit, to which parallel conversion has been applied in the S/P conversion circuits 1 and 6, carrier modulation circuits 3 and 8 for conducting mapping on coordinates of I and Q axes in accordance with a modulation method of each carrier, modulation method setting circuits 4 and 9 for extracting a modulation method of a carrier from the CONT data C1, and setting a modulation method in each block, an OFDM frame generating circuit 11 for conducting a carrier arrangement of data mapped in the carrier modulation circuits 3 and 8, in accordance with an arrangement of a symbol and a frame of OFDM, and a frame information generating circuit 12 for extracting the OFDM symbol and frame arrangement from the CONT data C1.

However, in the conventional modulation device, even though carriers of different modulation methods exist within a band, a modulation level of each carrier is set so that electric power becomes all the same as each other. In other words, in the conventional modulation device, there is no circuit for setting a modulation level of a carrier, and the setting of a modulation level for every carrier modulation method is not conducted. Accordingly, all of the modulation levels are the same, and the modulation level setting for every carrier cannot be conducted.

For example, in case that QPSK modulation is applied to a voice signal in one segment out of the 13 segments, and 64QAM modulation is applied to a video signal in the remaining 12 segments, and the signals are transmitted, each of the QPSK-modulated voice signal and the 64QAM-modulated video signal is transmitted at the same modulation level.

Next, a relationship between these QPSK-modulated voice signal and 64QAM-modulated video signal will be explained. FIG. 10 is a schematic view (a map) showing one example of a receivable range of a transmission signal. Dependent on a modulation method, receivable required C/N ratios (Carrier to Noise Ratios) are different from each other, and the required C/N ratio becomes larger as the modulation becomes multilevel modulation. In other words, the required C/N ratio in the 64QAM modulation becomes larger than that in the QPSK modulation. Accordingly, if the voice signal using the QPSK modulation and the video signal using the 64QAM modulation are transmitted at the same modulation level, a reception device that exists in a region A1 within a radius R1 from a transmission point P1 can receive both of the voice signal and the video signal, and however, in a reception device that exists in a region A2 between a point of a radius R1 and a point of a radius R2 (R1<R2), a phenomenon that the voice signal can be received and however, the video signal cannot be received occurs. In this region A2, since the voice signal can be received and however, the video signal cannot be received, finally the reception of television broadcasting cannot be completely conducted.

On the other hand, other examples of this kind of technology are disclosed in JP-A-321765/1995 (referred to as a prior art 1, hereinafter) and JP-A-145928/1999 (referred to as a prior art 2, hereinafter). The objective of the technologies disclosed in these prior arts 1 and 2 is to reduce interference disturbance to other service by changing a magnitude of electric power for each carrier to prevent disturbance from concentrating on a specific layer even in case that only a specific band within a transmission band is subject to a large effect due to multi-path disturbance.

Referring to these prior arts 1 and 2, these are similar to the present invention in a point that a magnitude of electric power for each carrier is changed, and however, the objective of the present invention is, as mentioned later, to enlarge a receivable range of the television broadcasting, and the objective thereof is quite different from that of these prior arts 1 and 2. Accordingly, a quantity of changing the magnitude of electric power (to distribute the electric power in how ratio for every segment) is quite different from each other between the prior arts 1 and 2 and the present invention. Therefore, the arrangement, effect and advantage of the invention described in the prior arts 1 and 2 are quite different from those of the present invention.

### SUMMARY OF THE INVENTION

The objective of the present invention is to enlarge the receivable range of the television broadcasting to a region A3 of a radius R3 (R1<R3<R2) from the region A1 of the radius R1 in FIG. 10 by decreasing the modulation level of the voice signal by predetermined quantity and increasing the modulation level of the video signal by resultant decreased transmission average electric power.

Another objective of the present invention is to provide a broadcasting apparatus using an OFDM modulation method, which is capable of enlarging the receivable range of the television broadcasting more than the conventional one.

In order to solve the above-described tasks, the present invention is a broadcasting apparatus using an OFDM modulation method, in which a band is divided into a plurality of layers, and a modulation method is set for each layer, characterized in that said broadcasting apparatus includes modulation level setting means for setting a modulation level of a carrier for each layer, and in said modulation level setting means, the modulation level of said carrier is set so that a receivable range of a modulation signal of each layer becomes the same range as each other.

Also, the present invention is characterized in that, in said modulation level setting means, a modulation level of a layer for video signal modulation is held at a predetermined level, and a modulation level of a layer for voice signal modulation is reduced below a predetermined level.

Also, the present invention is characterized in that the apparatus further comprises amplification means for amplifying a modulation signal of each layer after modulation level setting to predetermined transmission electric power.

Also, the present invention is characterized in that said predetermined transmission electric power is average electric power of a band in a case where a modulation level of each layer is the same as each other.

Also, the present invention is characterized in that any of 64QAM modulation, 16QAM modulation and DQPSK modulation is used for the video signal modulation, and QPSK modulation is used for the voice signal modulation.

Also, the present invention is characterized in that said each layer is further divided into a singular segment or a plurality of segments.

Also, the present invention is the apparatus comprising: a serial-parallel conversion circuit for converting a serial data for each layer into a parallel data in accordance with a modulation method, an interleave circuit for delaying and interleaving a parallel data for every bit, which is output from said serial-parallel conversion circuit, a carrier modulation circuit for conducting mapping on coordinates of I and Q axes in accordance with a modulation method of each carrier, a modulation method setting circuit for extracting a modulation method of a carrier from a control data corresponding to a serial data for said every layer, and setting a modulation method in each block, and said modulation level setting means for setting a modulation level of a carrier to be mapped, based on a modulation method set in said modulation method setting circuit.

Also, the present invention is characterized in that an arrangement between said serial-parallel conversion circuit and said modulation level setting means is constructed by only one layer, and a data of a modulation method different from others is included in a data for said one layer.

Also, the present invention is characterized in that the apparatus further comprises: an OFDM frame generating circuit for conducting a carrier arrangement of a data mapped in said carrier modulation circuit in accordance with an arrangement of a symbol and a frame of OFDM, and a frame information generating circuit for extracting OFDM frame arrangement information from said control data, and outputting it to said OFDM frame generating circuit.

Also, the present invention is characterized in that the apparatus is constructed of a studio device for conducting digital conversion and signal compression of video and voice, an OFDM modulation device for conducting OFDM modulation of a digital signal after the compression, and a transmission device for amplifying the digital signal after the OFDM modulation and transmitting it, and said OFDM modulation device includes said modulation level setting means.

Also, the present invention is characterized in that said transmission device comprises said amplification means for amplifying the digital signal after the OFDM modulation to a predetermined transmission electric power.

Also, the present invention is characterized in that said OFDM modulation device comprises a layer division section for conducting layer division of the digital signal from said studio device, an error correction coding section for conducting error correction coding of the signal for every layer after the layer division, a byte-interleave section for byte-interleaving the digital signal after the error correction coding, a convolution coding section for conducting convolution coding of the byte-interleaved digital signal, and a punctured coding section for conducting punctured coding of the convolution-coded digital signal.

Also, the present invention is characterized in that said OFDM modulation device includes an inverse Fourier transform section for conducting inverse Fourier transform of I channel and Q channel modulation data from said OFDM frame generating circuit, a first local oscillator, a phase shift section for shifting a phase of an output from said first local oscillator, an integration section for integrating each output from said inverse Fourier transform section and an output from said phase shift section, an adder for adding outputs from said integration section, a digital/analog converter for converting an output from said adder into an analog data, a second local oscillator, and an integration section for integrating an output from said second local oscillator and an output from said digital/analog converter.

According to the present invention, since the modulation level of the carrier is set for every layer, it becomes possible to make the receivable range of the modulation signal of each layer the same range as each other. Accordingly, it becomes possible to enlarge the receivable range of the television broadcasting more than the conventional one.

### BRIEF DESCRIPTION OF THE DRAWINGS

This and other objects, features and advantages of the present invention will become more apparent upon a reading of the following detailed description and drawings, in which;

FIG. 1 is an arrangement view of one example of a middle section 35 of an OFDM modulation device 22 in a broadcasting apparatus using an OFDM modulation method, which is related to the present invention;

FIG. 2 is a whole arrangement view of one example of the broadcasting apparatus using the OFDM modulation method, which is used for a ground digital broadcasting system;

FIG. 3 is an arrangement view of one example of a former section 25 of the OFDM modulation device 22;

FIG. 4 is an arrangement view of one example of a latter section 41 of the OFDM modulation device 22;

FIG. 5 is a view showing a constellation of modulated data;

FIG. 6 is an arrangement view of a second embodiment;

FIGS. 7(A) and (B) are views showing one example of frequency allocation of television broadcasting;

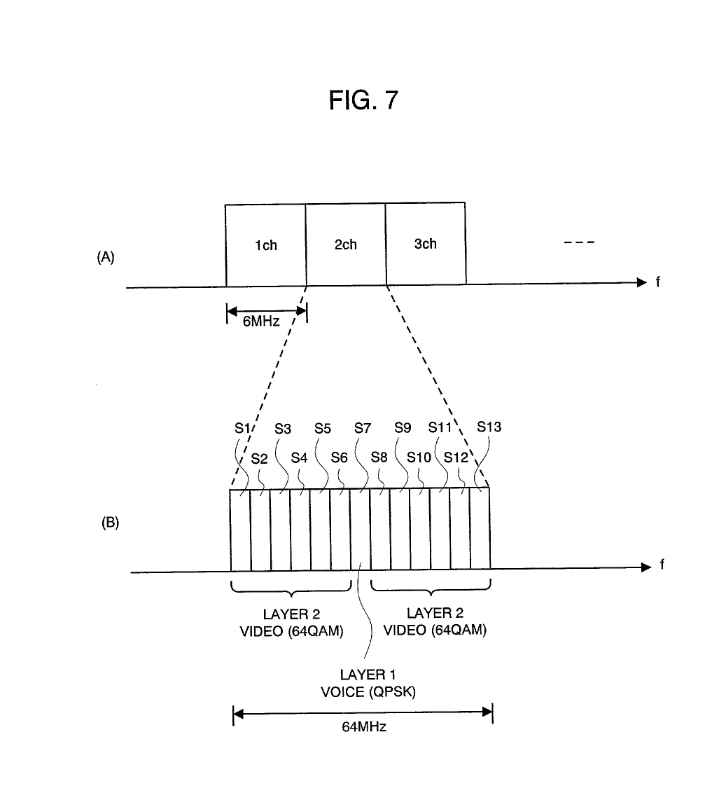

FIG. 8 is a circuit arrangement view of one example of a conventional broadcasting apparatus;

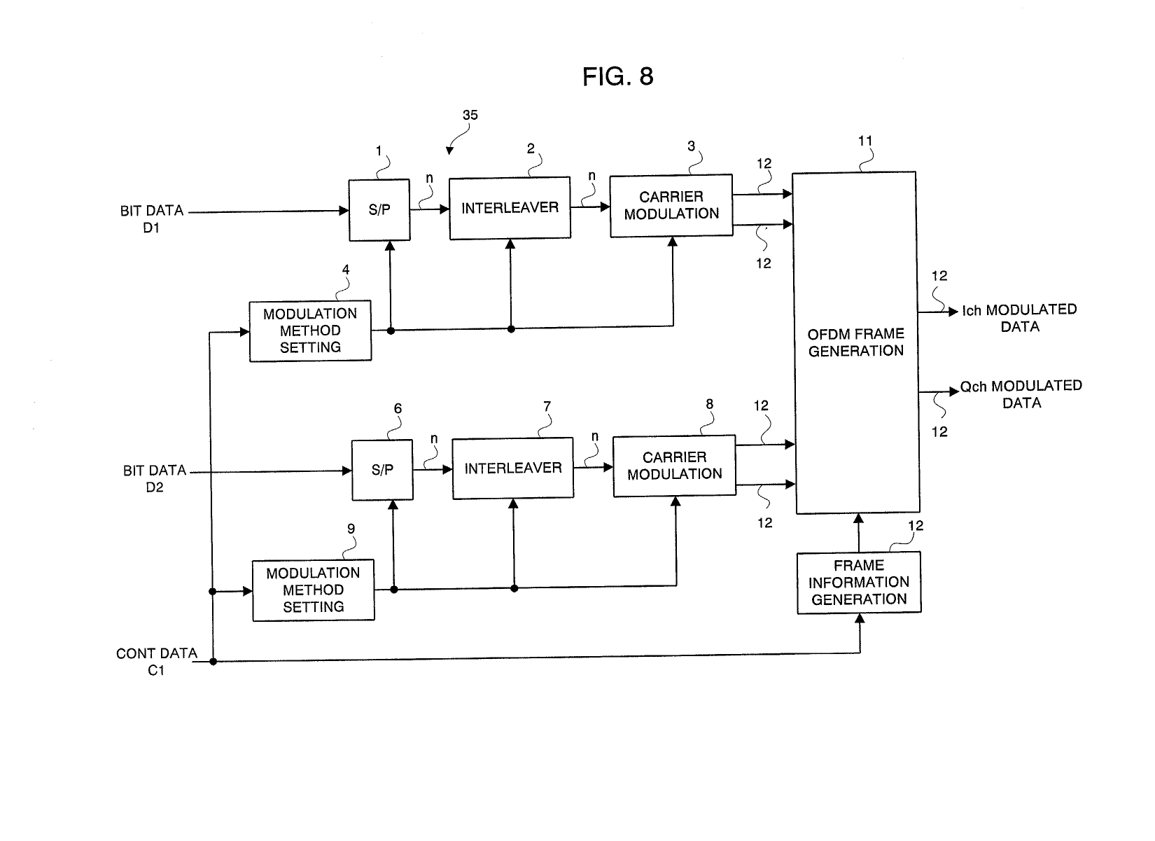

FIG. 9 is a view showing a conventional constellation;

FIG. 10 is a schematic view showing one example of a receivable range of a transmission signal.

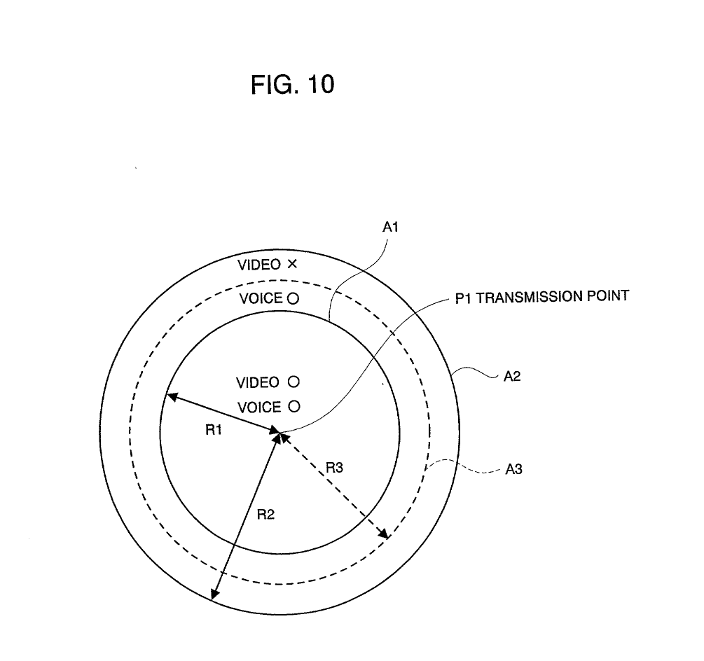

### DESCRIPTION OF THE EMBODIMENTS

First, an outline of the present invention will be explained. The present invention is characterized in that, in an OFDM modulation device, by selecting a modulation level for every modulation method of each carrier of an OFDM modulation wave, an apparatus that can realize reception in a wider range at the same average electric power same as the conventional one is proposed.

As mentioned above, in the ISDB-T apparatus, the band is divided into the 13 segments, and it has a characteristic that a modulation method and a coding rate or the like are set for each segment. Also, as mentioned above, dependent on a modulation method, the receivable required C/N ratios are different from each other, and the required C/N ratio becomes larger as the modulation becomes multilevel modulation. Taking it other way round, if a noise level is the same, the reception can be realized as the number of modulation becomes less even though a modulation level is less. Accordingly, it is possible to set a receivable distance of a modulation signal of each modulation method without changing average electric power of a band by adjusting a modulation level for each modulation method. In other words, by decreasing a modulation level of a carrier, the number of modulation of which is less, and increasing a modulation level of a carrier of multilevel modulation by resultant reduced transmission average electric power, it becomes possible to make a receivable range of a modulation signal the same range. In other words, it is possible to elongate a receivable distance of a transmission signal.

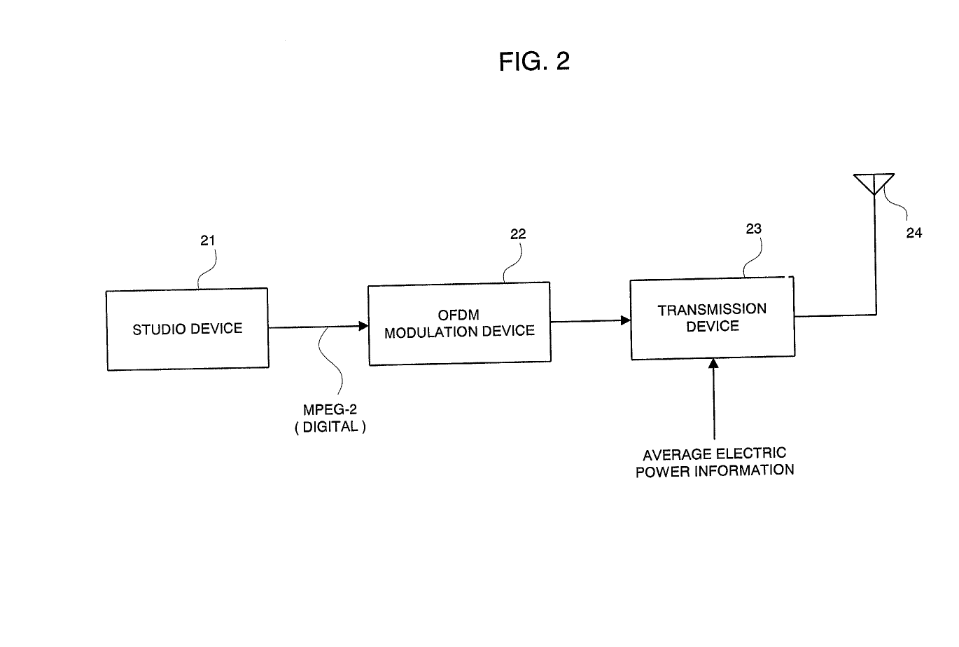

Below, referring to attached drawings, embodiments of the present invention will be explained. First, a first embodiment of the present invention will be explained. FIG. 2 is a whole arrangement view of one example of a broadcasting apparatus using an OFDM modulation method, which is used for a ground wave digital broadcasting system. Referring to the figure, the broadcasting apparatus is constructed of a studio device 21 for conducting digital conversion and signal compression of a video signal and a voice signal (by means of MPEG2, for example), an OFDM modulation device 22 for conducting OFDM modulation of a digital signal after the compression, a transmission device 23 for amplifying the digital signal after the OFDM modulation and transmitting it, and a transmission antenna 24.

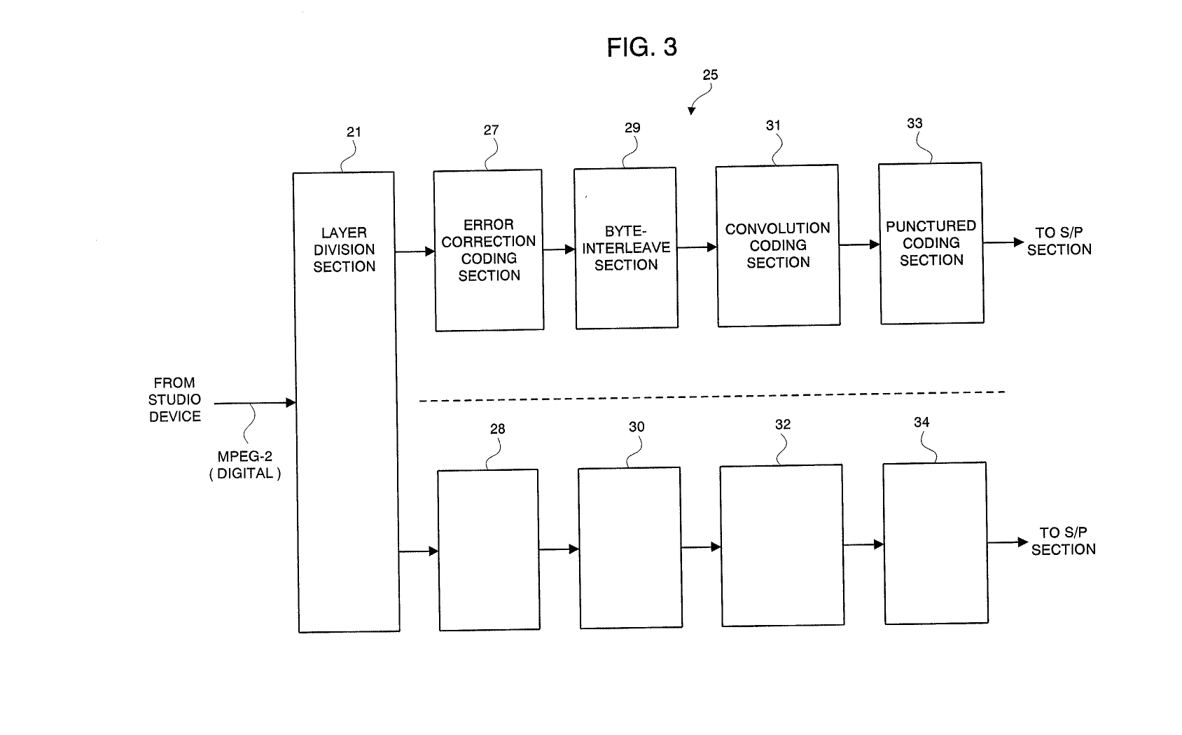

FIG. 3 is an arrangement view of one example of a former section 25 of the OFDM modulation device 22. Referring to the figure, the former section 25 of the OFDM modulation device 22 is constructed of a layer division section 26 for conducting layer division of the digital signal from the studio device 21, error correction coding sections 27 and 28 for conducting error correction coding of the signals for every layer after the layer division, byte-interleave sections 29 and 30 for byte-interleaving the digital signals after the error correction coding, convolution coding sections 31 and 32 for conducting convolution coding of the byte-interleaved digital signals, and punctured coding sections 33 and 34 for conducting punctured coding of the convolution-coded digital signals.

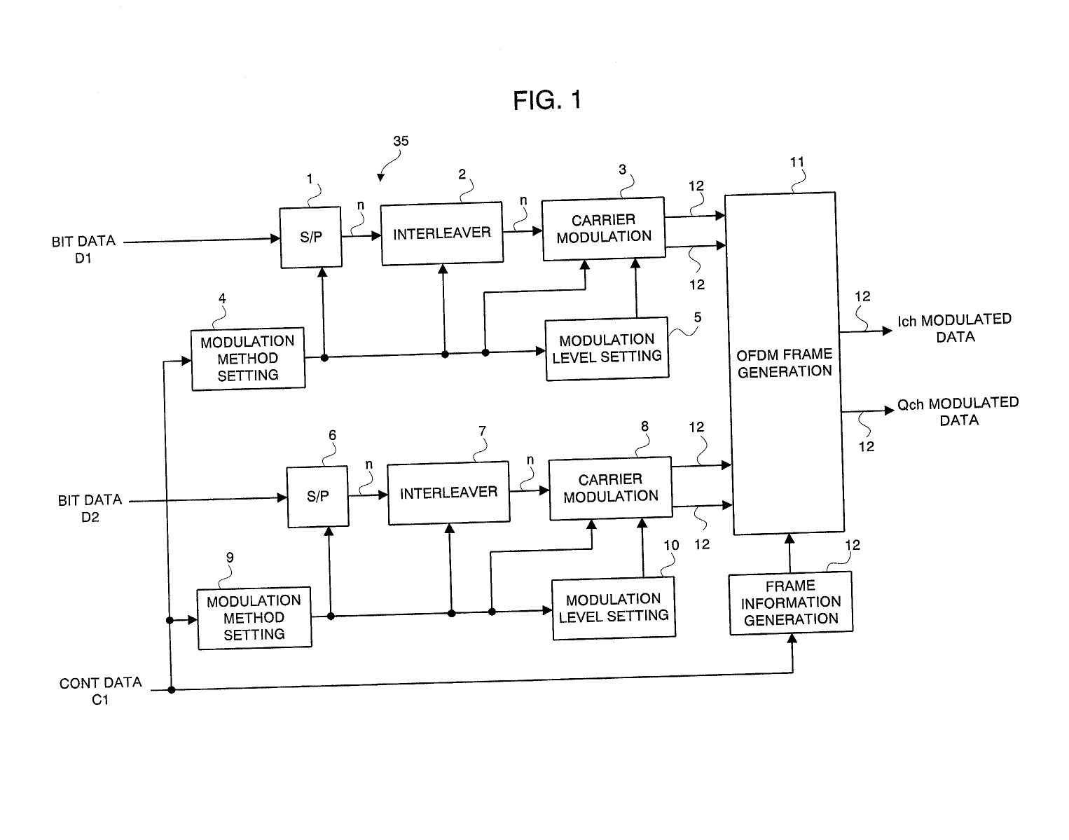

FIG. 1 is an arrangement view of one example of a middle section 35 of the OFDM modulation device 22. Referring to the figure, the middle section 35 of the OFDM modulation device 22 is constructed of serial-parallel conversion circuits (referred to as S/P conversion circuits, hereinafter) 1 and 6 for converting bit data D1 and D2 from the punctured coding sections 33 and 34 of the former section 25 into parallel data in accordance with a modulation method, interleave circuits 2 and 7 for delaying and interleaving the parallel data for every bit, carrier modulation circuits 3 and 8 for mapping the data after the interleaving on coordinates of I and Q axes in accordance with a modulation method of each carrier, modulation method setting circuits 4 and 9 for extracting a modulation method of a carrier from a CONT data C1, and setting the modulation method in each block, modulation level setting circuits 5 and 10 for setting a modulation level of a carrier to be mapped, based on the modulation method set in the modulation method setting circuits 4 and 9, an OFDM frame generating circuit 11 for conducting a carrier arrangement of data mapped in the carrier modulation circuits 3 and 8 in accordance with an arrangement of a symbol and a frame of OFDM, and a frame information generating circuit 12 for extracting OFDM frame arrangement information from the CONT data C1.

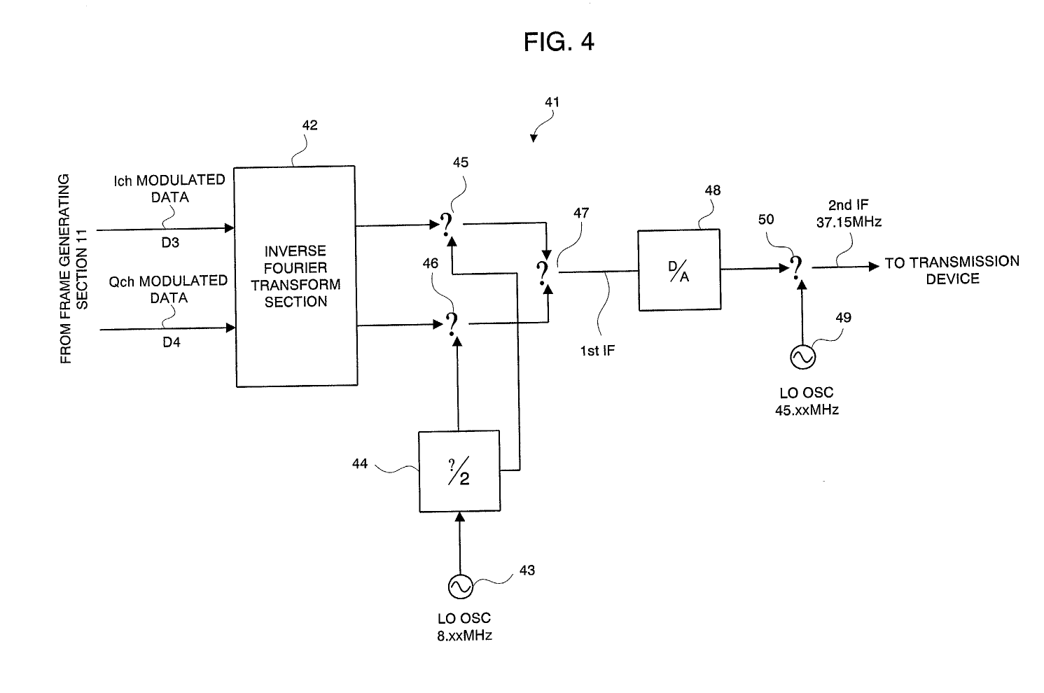

FIG. 4 is an arrangement view of one example of a latter section 41 of the OFDM modulation device 22. Referring to the figure, the latter section 41 of the OFDM modulation device 22 is constructed of an inverse Fourier transform section 42 for conducting inverse Fourier transform of I channel and Q channel modulation data D3 and D4 from the OFDM frame generating circuit 11, a local oscillator (for example, an oscillation frequency 8 MHz band) 43, a phase shift section 44 for shifting a phase of an output from the local oscillator 43 by π/2, integration sections 45 and 46 for integrating each output from the inverse Fourier transform section 42 and an output from the phase shift section 44, an adder 47 for adding outputs from the integration sections 45 and 46, a digital/analog converter (D/A) 48 for converting an output from the adder 47 into an analog data, a local oscillator (for example, an oscillation frequency 45 MHz band) 49, and an integration section 50 for integrating an output from the local oscillator 49 and an output from the D/A 48. And, an output from the integration section 50 is output to the transmission device 23.

Next, referring to FIG. 1, an operation of the middle section 35 of the OFDM modulation device 22 will be explained. Although here a case where 64QAM modulation is used for transmission of video and QPSK modulation is used for transmission of voice will be explained, other modulation, for example, a case where 16QAM modulation or DQPSK (Differential QPSK) modulation is used for the transmission of video can be explained in the same manner. In the CONT data C1, as mentioned above, a modulation method, an error correction coding rate and other layer arrangement information for every segment of each layer are included. In the middle section 35 of the OFDM modulation device 22, the input bit data D1 and D2 are modulated based on a data representing the modulation method included within the CONT data C1.

First, in the modulation method setting circuit 4, a data representing the modulation method within the input CONT data C1 is extracted, and a setting value of the 64QAM modulation method is obtained. And, based on the obtained setting value, the setting of each block is conducted. Also, in the modulation level setting circuit 5, based on the modulation method set in the modulation method setting circuit 4, the setting of a modulation level of carrier modulation is conducted, and the level setting value is output to the carrier modulation circuit 3.

On the other hand, in the S/P conversion circuit 1, in order to apply the 64QAM modulation to the input bit data D1, the bit data D1 is converted into a parallel data of 6 bits. Thereafter, in the interleaver 2, delay processing is applied to the parallel data of 6 bits, which is different for every bit, and the data is interleaved. Next, in the carrier modulation circuit 3, based on the 6 bit data interleaved in the interleaver 2, the setting value set in the modulation method setting circuit 4, and the modulation level set in the modulation level setting circuit 5, carrier modulation (mapping) is conducted, and the data becomes a data of 12 bits.

In the same manner, in the modulation method setting circuit 9, a data representing the modulation method within the input CONT data D2 is extracted, and a setting value of the QPSK modulation method is obtained. And, based on the obtained setting value, the setting of each block is conducted. Also, in the modulation level setting circuit 10, based on the modulation method set in the modulation method setting circuit 9, the setting of a modulation level of carrier modulation is conducted, and the level setting value is output to the carrier modulation circuit 8.

On the other hand, in the S/P conversion circuit 6, in order to apply the QPSK modulation to the input bit data D2, the bit data D2 is converted into a parallel data of 6 bits. Thereafter, in the interleaver 7, delay processing is applied to the parallel data of 6 bits, which is different for every bit, and the data is interleaved. Next, in the carrier modulation circuit 8, based on the 6 bit data interleaved in the interleaver 7, the setting value set in the modulation method setting circuit 9, and the modulation level set in the modulation level setting circuit 10, carrier modulation (mapping) is conducted, and the data becomes a data of 12 bits.

And, in the frame information generating circuit 12, a data representing frame arrangement information within the CONT data C1 is extracted, and is output to the OFDM frame generating circuit 11. Finally, in the OFDM frame generating circuit 11, the 64QAM modulation data modulated in the carrier modulation circuit 3 and the QPSK modulation data modulated in the carrier modulation circuit 8 are allocated to each carrier in accordance with frame arrangement information of OFDM, and OFDM symbol and frame are generated.

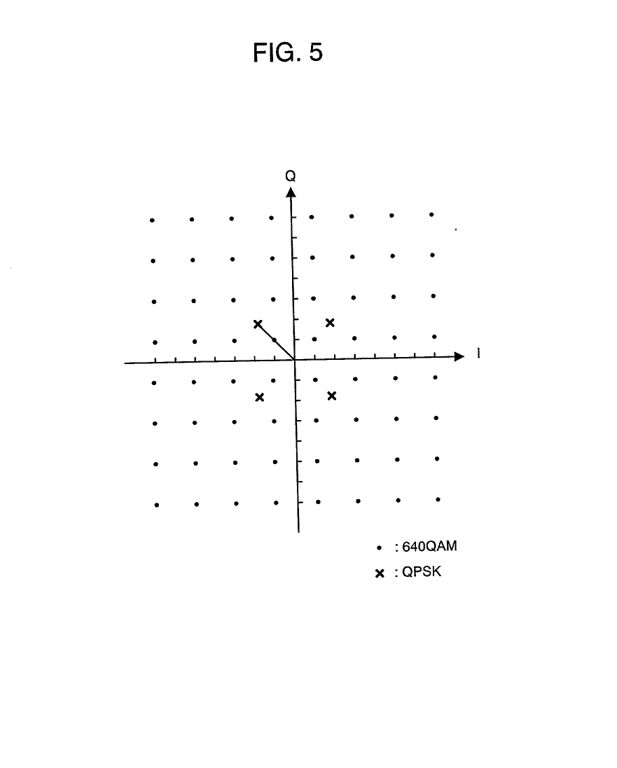

FIG. 5 is a view showing a constellation of modulated data. In the figure, a spot (a dot) and X show a data of 64QAM and a data of QPSK, respectively. The length of a straight line connecting each point to a point (0 point) of intersection of an I axis and a Q axis indicates a modulation level of the data.

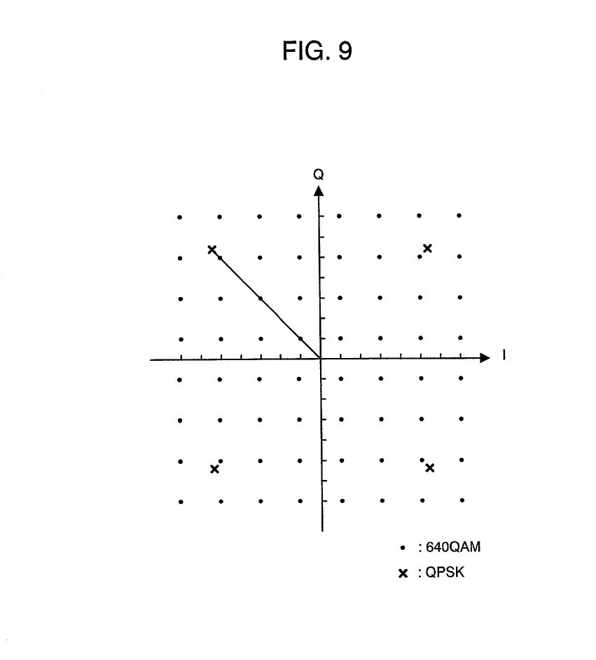

If this is compared with a view showing a conventional constellation in FIG. 9, with regard to the 64QAM data, there is no difference of the modulation levels between the present invention and the conventional one. However, with regard to the QPSK data, compared with the conventional one, the modulation level in the present invention becomes less. This is because the modulation level of a carrier of the QPSK modulation was decreased in the modulation level setting circuit 10. A width of the decrease is the width such that a receivable range of a 64QAM modulation wave (video) and a QPSK modulation wave (voice) become the same range.

On the other hand, since the modulation level of a carrier of the QPSK modulation was decreased, average electric power of a transmission signal would be decreased by the decrease. Accordingly, an output from the OFDM modulation device 22 is amplified in the transmission device 23 so as to be predetermined average electric power defined in advance in the transmission device 23. In addition, the predetermined average electric power in the transmission device 23 can be arbitrarily set for example from the OFDM modulation device 22 and other device, for example the studio device 21.

In addition, in order not to change the average electric power, it is possible to decrease the modulation level of a carrier of the QPSK modulation and to increase the modulation level of a carrier of the 64QAM modulation.

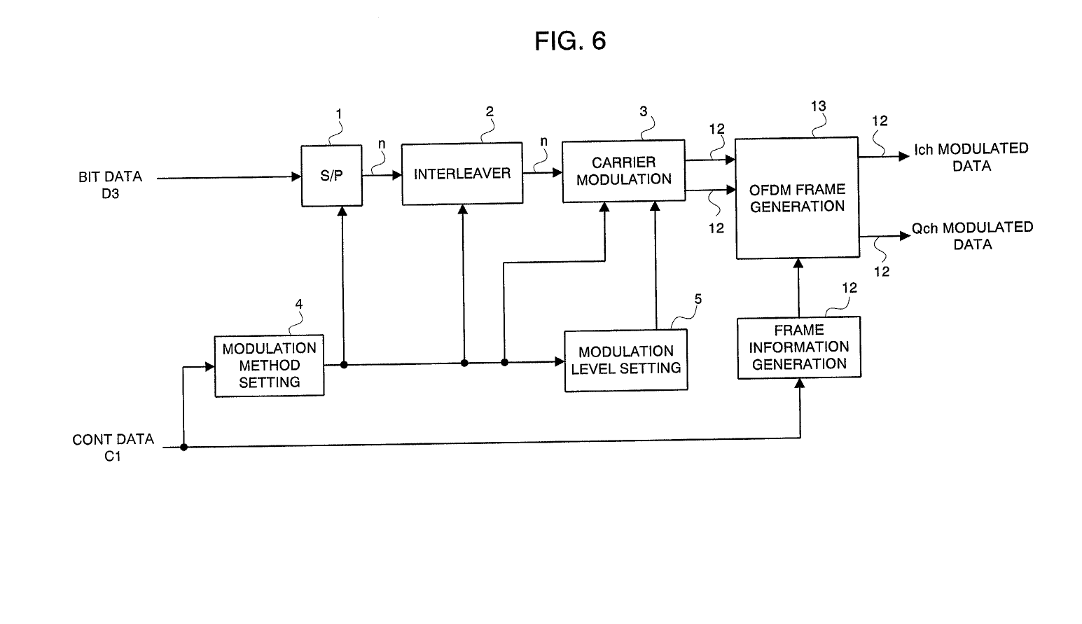

Next, a second embodiment of the present invention will be explained. FIG. 6 is an arrangement view of the second embodiment. An arrangement in FIG. 6 shows a case where, in an arrangement in FIG. 1, the circuits before carrier modulation become one system.

Although, in the first embodiment, a case where two bit data D1 and D2 were input as input data was mentioned, in the second embodiment, an input data is only a bit data D3. In the first embodiment, a video signal of the 64QAM modulation is input as the bit data D1, and a voice signal of the QPSK modulation is input as the bit data D2, and a method in which for example both of the video signal of the 64QMA modulation and the voice signal of the QPSK modulation are included in the bit data D1 is not supposed.

However, a method in which for example both of the video signal of the 64QMA modulation and the voice signal of the QPSK modulation are included in the bit data can be also supposed. Accordingly, in the second embodiment, a case where data of different modulation methods are input as this bit data D3 will be mentioned.

Referring to the figure, when in a modulation method setting circuit 4 a data representing a modulation method within the input CONT data C1 is extracted, and a setting value of the QPSK modulation method is obtained, in a modulation level setting circuit 5, a modulation level of a carrier is decreased. On the other hand, when a setting value of the 64QAM modulation method is obtained, in the modulation level setting circuit 5, the modulation level of a carrier is not changed. In this manner, an operation of the modulation level setting circuit 5 is the same as that in the first embodiment. Also, in this arrangement, since the setting of a modulation level for every modulation method can be realized, it is possible to obtain the same result as the first embodiment.

According to the present invention, since a broadcasting apparatus using an OFDM modulation method, in which a band is divided into a plurality of layers, and a modulation method is set for each layer, includes modulation level setting means for setting a modulation level of a carrier for each layer, and in said modulation level setting means, the modulation level of said carrier is set so that a receivable range of a modulation signal of each layer becomes the same range as each other, it becomes possible to make the receivable range of the modulation signal of each segment the same range as each other. Accordingly, it becomes possible to enlarge the receivable range of the television broadcasting more than the conventional one.

Particularly, if the receivable ranges for the video and voice are the same range by setting the modulation level of a carrier for every modulation method, electric power of a carrier of the QPSK modulation becomes less than that of a carrier of the 64QAM modulation. Accordingly, in case of average electric power same as the conventional one, the modulation level of the QAM modulation carrier becomes larger by the decrease of the modulation level of the 64 QPSK modulation carrier, and an advantage that the receivable range becomes wider is effected.

What is claimed is:

1. A broadcasting apparatus using an OFDM modulation method, in which a band is divided into a plurality of layers, and a modulation method is set for each layer,
characterized in that the broadcasting apparatus using an OFDM modulation method comprises modulation level setting means for setting a modulation level of a carrier for each layer, and in said modulation level setting means, the modulation level of said carrier is set so that a receivable range of a modulation signal of each layer becomes the same range as each other.

2. A broadcasting apparatus using an OFDM modulation method recited in claim 1, characterized in that, in said modulation level setting means, a modulation level of a layer for video signal modulation is held at a predetermined level, and a modulation level of a layer for voice signal modulation is reduced below a predetermined level.

3. A broadcasting apparatus using an OFDM modulation method recited in claim 1, characterized in that the apparatus further comprises amplification means for amplifying a modulation signal of each layer after modulation level setting to predetermined transmission electric power.

4. A broadcasting apparatus using an OFDM modulation method recited in claim 3, characterized in that said predetermined transmission electric power is average electric power of a band in a case where a modulation level of each layer is the same as each other.

5. A broadcasting apparatus using an OFDM modulation method recited in claim 1, characterized in that any of 64QAM modulation, 16QAM modulation and DQPSK modulation is used for the video signal modulation, and QPSK modulation is used for the voice signal modulation.

6. A broadcasting apparatus using an OFDM modulation method recited in claim 1, characterized in that said each layer is further divided into a singular segment or a plurality of segments.

7. A broadcasting apparatus using an OFDM modulation method recited in claim 1, wherein the apparatus comprising:
a serial-parallel conversion circuit for converting a serial data for each layer into a parallel data in accordance with a modulation method,
an interleave circuit for delaying and interleaving a parallel data for every bit, which is output from said serial-parallel conversion circuit,
a carrier modulation circuit for conducting mapping on coordinates of I and Q axes in accordance with a modulation method of each carrier,
a modulation method setting circuit for extracting a modulation method of a carrier from a control data corresponding to a serial data for said every layer, and setting a modulation method in each block, and
said modulation level setting means for setting a modulation level of a carrier to be mapped, based on a modulation method set in said modulation method setting circuit.

8. A broadcasting apparatus using an OFDM modulation method recited in claim 7, characterized in that an arrangement between said serial-parallel conversion circuit and said modulation level setting means is constructed by only one layer, and a data of a modulation method different from others is included in a data for said one layer.

9. A broadcasting apparatus using an OFDM modulation method recited in claim 7, characterized in that the apparatus further comprises:
an OFDM frame generating circuit for conducting a carrier arrangement of a data mapped in said carrier modulation circuit in accordance with an arrangement of a symbol and a frame of OFDM, and
a frame information generating circuit for extracting OFDM frame arrangement information from said control data, and outputting it to said OFDM frame generating circuit.

10. A broadcasting apparatus using an OFDM modulation method recited in claim 1, characterized in that the apparatus is constructed of a studio device for conducting digital conversion and signal compression of video and voice, an OFDM modulation device for conducting OFDM modulation of a digital signal after the compression, and a transmission device for amplifying the digital signal after the OFDM modulation and transmitting it, and said OFDM modulation device includes said modulation level setting means.

11. A broadcasting apparatus using an OFDM modulation method recited in claim 10, characterized in that said transmission device comprises said amplification means for amplifying the digital signal after the OFDM modulation to a predetermined transmission electric power.

12. A broadcasting apparatus using an OFDM modulation method recited in claim, characterized in that said OFDM modulation device comprises a layer division section for conducting layer division of the digital signal from said studio device, an error correction coding section for conducting error correction coding of the signal for every layer after the layer division, a byte-interleave section for byte-interleaving the digital signal after the error correction coding, a convolution coding section for conducting convolution coding of the byte-interleaved digital signal, and a punctured coding section for conducting punctured coding of the convolution-coded digital signal.

13. A broadcasting apparatus using an OFDM modulation method recited in claim 10, characterized in that said OFDM modulation device includes an inverse Fourier transform section for conducting inverse Fourier transform of I channel and Q channel modulation data from said OFDM frame generating circuit, a first local oscillator, a phase shift section for shifting a phase of an output from said first local oscillator, an integration section for integrating each output from said inverse Fourier transform section and an output from said phase shift section, an adder for adding outputs from said integration section, a digital/analog converter for converting an output from said adder into an analog data, a second local oscillator, and an integration section for integrating an output from said second local oscillator and an output from said digital/analog converter.
